(19) United States
(12) Patent Application Publication
(10) Pub. No.: US 2007/0110015 A1
(43) Pub. Date: May 17, 2007

(54) Select diversity for radio communications

(75) Inventors: Shyam Chakraborty, Espoo (FI); Johan Torsner, Masaby (FI); Mats Fredrik Sagfors, Kyrkslatt (FI)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 11/546,568

(22) Filed: Oct. 12, 2006

(30) Foreign Application Priority Data
Oct. 19, 2005 (SE) 0502311-4

(51) Int. Cl. H04Q 7/24

(52) U.S. Cl. 370/338; 370/351; 455/525

(57) ABSTRACT

Select diversity in cellular radio communications involving both the radio access network and the mobile radio ensures that an optimal base station cell under a current condition is selected for communicating with the mobile radio. A candidate set of radio base station cells is defined for a radio connection between the radio network and the mobile radio. Packets are sent via the radio network to each of multiple radio base stations having a cell in the candidate set. The mobile radio detects a current quality of communication for the radio connection, and based on that detected quality, the candidate cell set may change. The mobile radio selects one of the cells in the candidate cell set to send a next or specific data packet based on one or more selection criteria.

### RELATED APPLICATION

This application claims priority from Swedish provisional application serial number 0502311-4, filed Oct. 19, 2005, and is related to commonly-assigned U.S. patent application Ser. No. 11/___,___,(atty ref:2380-1009), entitled, “Broadcast-Based Communication In A Radio Or Wireless Access Network To Support Mobility,” the contents of which are incorporated herein by reference.

### TECHNICAL FIELD

The technical field relates to cellular radio communications, and in particular, to select diversity in cellular radio communications.

### BACKGROUND

Handover is an important feature in all modem cellular systems where an established communications link or connection with a mobile radio is transferred from one cell (i.e., a geographical coverage area) to another cell to accommodate movement of the mobile radio and/or changing radio conditions. A radio base station is associated with each cell, and a network control node such as a radio network controller (RNC) or base station controller (BSC) may control multiple radio base stations. When new radio access technologies are developed, like in the long-term evolution (LTE) of third generation cellular communications like 3GPP, there is a need to define efficient handover schemes that provide lossless, seamless, and fast handover of a connection with a mobile without packet duplicates.

High-Speed Downlink Packet Access (HSDPA) is specified in 3GPP Release 5. With HSDPA, wideband code division multiple access (WCDMA) cellular systems include additional transport and control channels, such as the high-speed downlink shared channel (HS-DSCH), which provides enhanced support for interactive, background and, to some extent, streaming services. Downlink (i.e., from the radio network to the mobile radio) systems that provide High-Speed Downlink Packet Access (HSDPA) have a hybrid automatic repeat request (HARQ) protocol that is used between the radio base station (sometimes called a Node B in 3G) and the mobile radio (called a user equipment (UE) in 3G) to retransmit packets that are not received or erroneously received at the mobile station. That HARQ protocol is handled at a media access control (MAC) protocol layer. Acknowledged mode (AM) packet retransmissions may also be performed between an RNC and UE (typically at a radio link control (RLC) protocol layer) for applications requiring a low packet loss rate.

When a handover cell change to a new base station is performed at a specified “activation time,” the data packets stored in one or more transmit buffers in a current base station to be sent to the mobile radio are “flushed,” which implies that some data packets may be discarded. To compensate for this, RLC level retransmissions from the radio network controller will ensure that the RLC control entity retransmits those data packets via the new base station so that no data loss occurs. On the other hand, if a connection is established or is otherwise operating in an unacknowledged mode (UM), lost or erroneously-received data packets are not retransmitted.

For conversational services, data packets may be sent in the unacknowledged mode because the strict delay “budget” associated with a packet data conversational service does not tolerate delays associated with packet retransmissions. A problem then in this situation is that any data present in the current radio base station during the cell change and buffer flushing is lost. Although this data packet loss may be acceptable for conversational services, it is unacceptable as a general mobility solution when data integrity is important. Thus, with HSDPA operating in unacknowledged mode, it is difficult to achieve both uninterrupted/seamless and lossless handovers.

Another problem with the hard handover cell change mechanism of HS-DSCH relates to radio channel fading. Ideally, the downlink transmission between a radio base station and the user equipment should occur in a best cell currently showing the most favorable radio conditions for this downlink transmission. But this ideal situation is very hard to achieve with the mechanism described above, since the hard handover procedure is typically much slower than the dynamics of the channel fading. Thus, the downlink data may end up being transmitted in a cell that is not the best cell at the moment.

Soft-handover, which is a form of macro-diversity reception, is used in 3G systems to handle this problem. A mobile user equipment in soft-handover receives the same information from a set of multiple cells or transmitters. That cell set usually always includes the best cell-even in cases when the fading changes rapidly. However, soft-handover comes with several drawbacks which is why soft-handover was abandoned as a solution for Release-5 HS-DSCH and for downlink LTE in the evolving 3G systems.

First, soft-handover requires very strict network synchronization which complicates network deployment. The transmissions from multiple base station nodes must be simultaneous. Second, soft-handover does not permit independent adaptation of modulation and coding in each cell because the encoding and modulation scheme must be the same from all transmitters in the soft-handover communication. The HS-DSCH uses both link adaptation (with HARQ) and multi-user scheduling carried out from the base station rather than a base station controller node. But base station-based, multi-user scheduling is difficult to achieve along with soft handover because the simultaneous transmission scheduling in multiple base stations must be rigorously coordinated. The inventors recognized the need to facilitate distributed scheduling and link adaptation (with HARQ) in each radio base station so that the downlink transmission occurs in the best cell. In UTRAN, the cell change operation is primarily orchestrated by the RNC, which means a relatively long handover time due to the signalling transfers between the RNC, the mobile equipment, and the radio base stations. Third, link-layer efficiency can still be increased by ensuring that the transmission is always carried out in the best cell. Finally, packet transmission delays (caused, e.g., by aforementioned losses and subsequent re-transmissions) resulting from handover cell changes can still be further reduced.

Another issue to address is that user-plane architectures in the 3GPP UTRAN long-term evolution are moving towards a simplified network architecture, where a user plane Anchor Node (AN) or Access Gateway (AGW), like the RNC in UTRAN, only performs limited functions. For example, the move would substantially reduce or even eliminate handover and other mobility management functions performed by the anchor node, and off-load those functions to the radio base station nodes. But a consequence of such a functionality change is that acknowledged (AM) mode packet communications is not supported in the anchor node.

### SUMMARY

Select diversity in cellular radio communications involving both the radio access network and the mobile radio ensures that an optimal base station cell under a current condition is selected for communicating with the mobile radio. A candidate set of radio base station cells is defined for a radio connection between the radio network and the mobile radio. If the cells are controlled by multiple radio base-stations, then packets are sent (e.g., multi-casted) in the radio network to each of multiple radio base stations having a cell in the candidate set. The mobile radio detects a current quality of communication for the radio connection, and based on that detected quality, the candidate cell set may change. The mobile radio selects one of the cells in the candidate cell set to send a next or specific data packet based on one or more selection criteria.

A radio access network includes multiple radio base stations, where each radio base station is associated with one or more cells. A packet communication with the mobile is associated with a candidate set of cells for the mobile radio that can potentially transmit packets to the mobile radio. A first base station associated with one of the candidate set of cells has a receiver that receives a packet for possible downlink transmission to the mobile radio. The first base station determines whether the mobile radio has selected the first cell in the candidate set to transmit that packet to the mobile radio. If so, the first base station transmits the packet from the selected first cell to the mobile radio.

The selection may be part of a handover operation or part of a cell selection operation, and it may be based on one or more factors including one or more radio conditions, one or more radio network conditions, or one or more mobile radio subscription conditions. At least a second one of the base stations having a second cell in the candidate set receives the packet for possible downlink transmission to the mobile radio. Because the mobile radio has selected the first base station to send this packet, in one example implementation, the second unselected base station does not transmit the packet to the mobile radio. Alternatively, in other example implementations, the mobile radio may select both the first and second base stations to transmit the packet to the mobile radio. In the latter case, both base stations need not be synchronized when they independently transmit the packet.

A benefit of this independence between the first and second base stations is that the first base station can transmit a packet (the same packet or different packets) to the mobile radio using a first modulation and/or coding scheme that is different from a second modulation and/or coding scheme used by the second base station to transmit a packet to the mobile radio.

In specific example implementations, the first base station may receive an acknowledgement of a packet previously-received by the mobile radio. The first base station may also receive a packet identifier of a previously-received data packet or of a packet to be transmitted by the first base station. Moreover, each radio base station having a cell in the candidate set has a buffer to store one or more packets to be transmitted downlink to the mobile radio. If another one of the radio base stations has transmitted or transmit a packet stored in the base station's buffer, the base station removes that packet from its buffer.

An anchor node is provided to facilitate transmission of data packets downlink from the radio access network to the mobile radio. The anchor node includes a memory for storing a candidate set of cells for the mobile radio. The node sends packets to be transmitted to the mobile radio to each base station associated with at least one of the cells in the candidate set of cells. The mobile radio effectively selects which of the base stations associated with at least one of the cells in the candidate set of cells will transmit a specific packet to the mobile radio.

The anchor node receives information associated with the mobile station regarding one or more conditions associated with cells in the candidate set. A new cell may be added to the candidate set or an existing cell deleted from the candidate set (or both) based on the received information. After a cell is added or deleted, packets to be transmitted to the mobile radio are only sent to those base stations currently having a cell in the candidate list. In one example embodiment, the anchor node is located in the radio access network and because of the select diversity technology need only provide limited radio link management functionality.

The mobile radio also facilitates the downlink data transmission. The mobile radio selects a cell in the candidate set for transmitting a packet to the mobile radio. The mobile signals to the radio base station associated with the selected cell an indication to transmit the packet to the mobile radio and then receives the packet transmitted from the selected cell. The mobile radio may select only one in the candidate set, or it may select two or more cells in the candidate set which are associated with different base stations to transmit the packet to the mobile radio. For example, the selection may be part of a handover operation or part of a cell selection operation. If the mobile selects two or more cells in the candidate set which are associated with different base stations to transmit a to the mobile radio, those packets may be different or they can be the same.

This technology is particularly advantageous in a cellular radio communications system with limited user-plane mobility functionality in anchor nodes coupled to multiple base stations. But the technology has wide applicability to all cellular systems because it provides a fast, efficient, and reliable cell change procedure that enables handover without data packet loss or duplication. It also ensures that a mobile radio receives data from a strong cell in the candidate cell set even under fading channel conditions. In contrast to existing soft-handover procedures, the select diversity technology does not require tight synchronization between the base-stations, it facilitates the independent use of link-adaptation (modulation and coding) as well as multi-user scheduling in each cell.

### BRIEF DESCRIPTION OF THE DRAWINGS

FIG. 1 illustrates a function block diagram of a non-limiting example cellular communications system;

FIG. 2 illustrates a diagram illustrating an example of a handover;

FIG. 3 is a flow chart diagram illustrating non-limiting, example mobility management procedures;

FIG. 4 is a function block diagram of a non-limiting example anchor node;

FIG. 5 is a function block diagram of a non-limiting example radio base station;

FIG. 6 is a function block diagram of a non-limiting example mobile radio;

FIGS. 7-15 illustrate example handover situations; and

FIG. 16 illustrates an example embodiment where the mobile selects different packets to be transmitted in parallel from different base stations.

### DETAILED DESCRIPTION

The following description sets forth specific details, such as particular embodiments, procedures, techniques, etc. for purposes of explanation and not limitation. But it will be appreciated by one skilled in the art that other embodiments may be employed apart from these specific details. For example, although the following description is facilitated using a non-limiting example application to handover in a cellular communications network, the technology may be employed in any wireless network and in any situation where it is desirable to use select diversity. In some instances, detailed descriptions of well known methods, interfaces, circuits, and device are omitted so as not obscure the description with unnecessary detail. Moreover, individual blocks are shown in some of the figures. Those skilled in the art will appreciate that the functions of those blocks may be implemented using individual hardware circuits, using software programs and data, in conjunction with a suitably programmed digital microprocessor or general purpose computer, using application specific integrated circuitry (ASIC), and/or using one or more digital signal processors (DSPs).

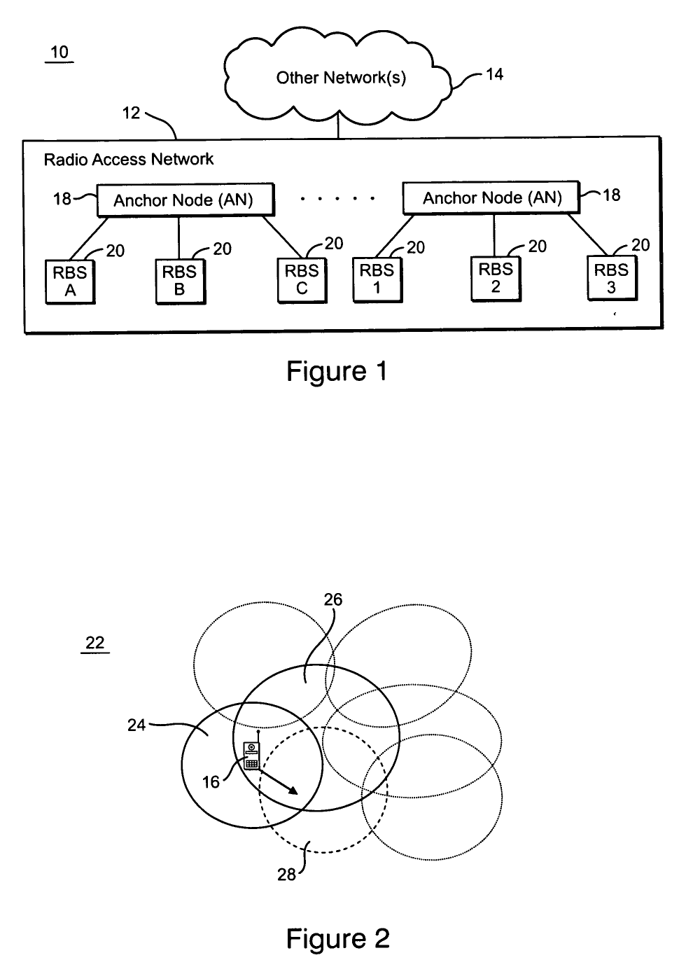

FIG. 1 illustrates a non-limiting example of a radio communications system 10. A radio access network (RAN) 12 is coupled to one or more other networks, examples of which include one or more core networks, the Internet, the PSTN, etc. One non-limiting example of a RAN is a Universal Mobile Telecommunications System (UMTS) terrestrial radio access network (UTRAN). Other non-limiting examples include wireless local area networks (WLANs), satellite radio networks, etc. The radio access network 12 includes one or more anchor nodes (AN) 18. Each anchor node 18 is coupled to one or more radio base stations 20. The term radio base station as used here includes any type of access point in a radio access network that enables communication between a mobile radio and another entity via the RAN 12, and includes such entities as AP (Access Point in a Wireless LAN system) or Node B in UTRAN. The radio base stations 20 communicate with mobile radios 16 over a radio or air interface using suitable radio channels or links. The term mobile radio as used here includes any type of portable device that can communicate over a wireless interface.

Each radio base station is associated with one or more geographical coverage areas or cells. FIG. 2 illustrates an example of a cellular radio communications system 22 with multiple cells. A mobile radio 16 having an active data packet connection established via the RAN 12 is moving in the direction of the arrow. The mobile radio 16 monitors the signal quality of downlink transmissions (e.g., on a pilot, broadcast, or other channel) from the current base station cell 24 serving an active connection with the mobile station as well as from base stations in neighboring cells. A candidate set of cells or base stations whose transmissions meet one or more specific criteria is maintained for the mobile's connection. Inclusion of base station cells in the candidate set may be based, for example, on a signal to noise ratio (SNR) of the downlink transmission exceeding a threshold, an average SNR remaining above a threshold for some period of time, etc. Similarly, a radio base station cell may be removed from the candidate cell set based on one or more criteria. Any suitable candidate cell set inclusion and removal parameters may be used.

Information of the candidate cell sets is maintained in the mobile station 16, the base station(s) 20 having a cell in the cell set, and in the anchor node(s) 18 coupled to the base station(s) having cells in the candidate cell set. Candidate cell set additions and/or deletions may be controlled by the anchor node 18, but may also be assisted by the mobile radio 16 and/or the radio base stations 20 or some other control entity. All involved nodes are preferably informed immediately of candidate cell set additions and/or deletions. In a preferred example embodiment, the mobile station 16 reports its cell measurements to a network entity, and the network entity then includes or removes cells to the candidate cell set.

In this example, there are two cells 24 and 26 currently in the mobile radio's candidate cell set (CS). In this example, if the two cells in the candidate set are governed by different radio base stations, the anchor node sends data packets for downlink transmission to the mobile station 16 to both radio base stations associated with cells 24 and 26. As the mobile station 16 moves in the direction of the arrow, a third cell 28 will soon be added to the mobile's candidate cell set. When it is, the anchor node 18 includes the third cell 28 in the candidate cell set. Based upon current downlink quality measurements and/or one or more other factors, the mobile radio chooses to receive data from any of the cells in its candidate set.

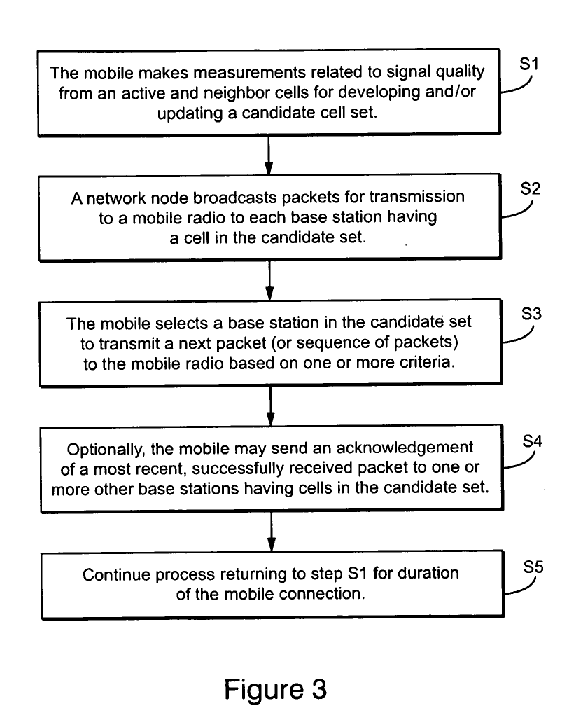

Example non-limiting procedures for mobility management in a radio communications system like that shown in FIG. 1 are now described in conjunction with the flowchart diagram in FIG. 3. Measurements are made related to the signal quality from an active and neighbour cells for developing and updating a candidate cell set (step S1). Other measurements could be made such as cell load, subscription factors like quality of service, etc. An anchor node sends packets for transmission to a mobile radio to each base station having a cell in the candidate cell set (step S2). One (or more) base stations is selected by the mobile radio from the candidate set to transmit a next packet (or sequence of packets) to the mobile radio based on one or more selection criteria (step S3). Optionally, the mobile radio may send an acknowledgement message for a most recent, successfully received packet to one or more other base stations having cells in the candidate set (step S4). This process is repeated (returning to step S1) for the duration of the mobile radio connection (step S5). Although the mobile cell-selection and maintenance of the candidate cell set are described here as one procedure, they could be implemented as two independent procedures. One procedure could be the control of the candidate set as one mobile and network procedure (steps S1 and S2), and another procedure where the cell selection is just mobile procedure(steps S3 & S4).

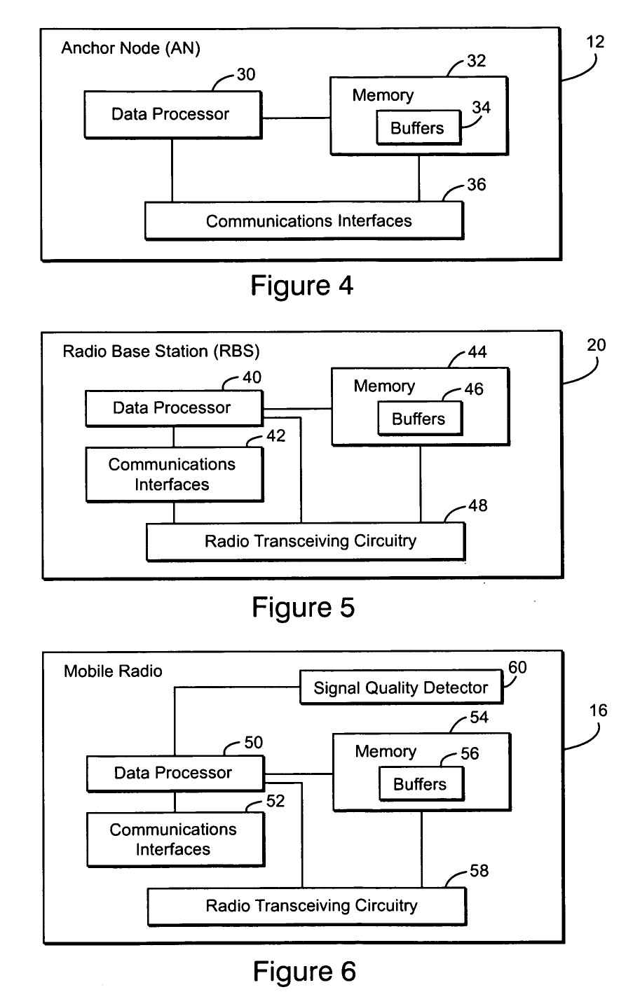

Function block diagrams in FIGS. 4-6 for the anchor node, radio base station, and mobile radio are now described. FIG. 4 is a function block diagram of a non-limiting example anchor node 18. A data processor 30 is coupled to a memory 32 and to one or more communications interfaces 36 for communicating with other nodes like radio base stations 20 and other anchor nodes as well as other networks 14. The memory 32 stores suitable programs and other software for controlling the processor 30 to perform its required functions and operations. Memory 32 may also include multiple data packet buffers 34 for storing packets to be transmitted to and received from various mobile stations 16 in cells associated with radio base stations coupled to the anchor node 18. But the anchor does not have to store any packets—it can simply forward them directly. In the downlink direction, the data processor sends data packets for the connection with the mobile radio so that all base stations governing cells in the candidate cell set receive the data packets to be sent to the mobile radio even though not all the base stations will be selected to transmit those data packets to the mobile radio 16. The maximum number of cells in the candidate set can be either pre-defined or dynamically selected depending upon the network conditions, load, etc.

The anchor node 18 may be located in a core network, in the RAN as a simplified controller node, or co-located with a radio base station. In FIG. 1, the anchor node 18 is shown for purposes of illustration only as a simplified controller node located in the RAN. The anchor node 18 may configure a transmission buffer (e.g., to hold several packets) for each active mobile connection that it receives packets for to pass along to the mobile radio 16. The processor 30 may stamp each packet to be transmitted over that mobile connection with a sequence number, e.g., an RLC sequence number, a MAC sequence number, PDCP sequence number, etc.

A controller (which may as a non-limiting example be part of the anchor node and implemented using the processor 30) controls the candidate cell set for each active mobile connection, receives signal quality measurements from the mobile radio, adds and deletes base station cells from the candidate set based on the measurements, and provides candidate cell set signalling to the mobile radio and radio base stations. That candidate cell set signalling includes reporting to the mobile radio those packets that have been transmitted to the different radio base stations.

FIG. 5 is a function block diagram of a non-limiting example radio base station 20. But nodes other than radio base station may be used that interface wireline and wireless links. The radio base stations 20 may be connected to the anchor node 18 in any configuration such as a star configuration as shown in the figures, a bus configuration, a chain configuration, etc. A data processor 40 is coupled to a memory 44 and to one or more communications interfaces 42 for communicating with other nodes like one or more anchor nodes 18, other radio base stations 20, and one or more mobile radios 16. The memory 44 stores suitable programs and other software for controlling the processor 40 to perform its required functions and operations. Memory 44 also includes multiple data packet buffers 46 for storing packets to be transmitted to and received from various mobile stations 16 in one or more cells associated with that radio base station. For data packets received from an anchor node 16 to be transmitted in the downlink direction to a mobile radio 18, the data processor 40 determines whether it has a cell in the candidate cell set for that mobile radio 18, and if so, it stores those data packets and awaits a selection indication from the mobile radio to transmit those data packets to the mobile radio 20. If such a selection indication is received, the radio base station transmits the buffered data packets over the radio interface to the mobile radio using the radio transceiving circuitry 48.

Because the radio base stations may be handling many mobile connections, they may have limited size buffers and some sort of buffer management procedures. One non-limiting, example procedure now explained is front-drop overflow control, although any type of packet flow control can be implemented. The anchor node 18, in turn, sends the packet from the top of its buffer to the base stations having cells in the mobile's candidate set. If the buffer for this mobile connection in any of the radio base stations in the candidate set is full, that buffer simply drops or discards the packet at the top of its buffer to accommodate the new packet.

In one example implementation, the mobile radio requests that the selected radio base station transmit a packet only from the top of its buffer. Otherwise, the base station must “purge” or discard all preceding packets until the packet requested is reached in that transmission buffer. In another example, the radio base station buffers are first-in-first-out (FIFO) buffers that “drop-from-front” at times of buffer overflow.

The packet flow control may optionally include the mobile radio sending an acknowledgement (ACK) signal to a selected base station in the candidate cell set. In response, the base station sends the next packet after the acknowledged packet. Alternatively, a selected base station could simply respond to the mobile's selection by transmitting the next packet in its buffer. Another non-limiting alternative is for the mobile radio to send a selection message to one of the base stations specifying a packet sequence number of the packet to be transmitted. The base station processor 40 includes scheduling functionality for scheduling the transmission of data packets to the mobile radio 16. Each base station also includes circuitry for receiving and processing acknowledgements and/or packet sequence numbers from the mobile radio 16.

FIG. 6 is a function block diagram of a non-limiting example mobile radio 16. A data processor 50 is coupled to a memory 54 and a communications interface 52 for communicating with one or more radio base stations 20. The memory 54 stores suitable programs and other software for controlling the processor 50 to perform its required functions and operations. Memory 54 also includes one or more data packet buffers 56 for storing packets to be transmitted to and received from one or more radio base stations in the candidate set. A signal quality detector 60 detects a signal quality of a downlink transmission from each of the cells in its candidate cell set as well as other neighboring cells. Signal quality may be determined using any suitable, e.g., received signal strength, SNR, bit error rate or block error rate, etc. The signal quality measurement information may be sent to the anchor node or some other node to make the candidate set decisions. Alternatively, the processor 50 decides which cells to add to and delete from its candidate set using one or more criteria for evaluating the detected signal qualities so that more optimal cells are included in the candidate cell set and less optimal cells are not.

In select diversity, the mobile's processor 50 selects one or more base station cells from the candidate set to transmit a next packet to the mobile station. The mobile may make those decisions based on current channel qualities (e.g., choose the base station with the best channel quality), on network factors (e.g., cell or system load), subscription factors (e.g., quality of service subscribed to), etc. An indication of that base station cell selection is sent from the mobile so that the selected base station(s) know(s) to transmit a next or specified packet, and un-selected base stations know not to transmit the next packet or specified packet and can remove that packet from their respective transmit buffers. Radio transceiving circuitry 58 is used to transmit and receive information over the radio interface.

The processor 50 may be configured to report an acknowledgement “ACK” of a most recent, successfully-received packet to a “new” radio base station selected for a next packet transmission. In that case, the selected base station can simply send the packet that follows the acknowledged packet. Alternatively, the processor 50 may simply request a next packet, a packet having a particular identifier, or a part of a packet from any radio base station cell in the candidate set without sending such an acknowledgement message.

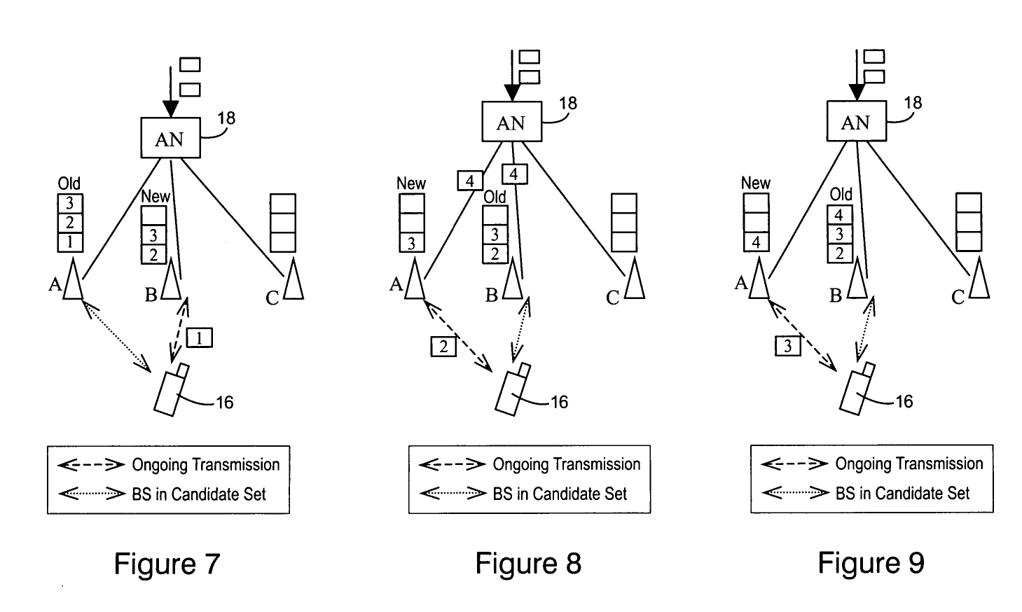

FIGS. 7-15 illustrate example cell reselection/mobility/handover situations. A dashed line in these figures represents an ongoing transmission between a base station and the mobile radio 16. A dotted line between a base station and the mobile radio indicates that a cell governed by the base station is in the active candidate cell set of the mobile radio. A dash-dotted line to and from an access node (AN) 18 marked with a number in a circle indicates a signaling message.

The examples in FIGS. 7-15 each show packets for a mobile radio 16 received at an anchor node 18. One cell associated with each of the radio base stations A and B is included in the candidate cell set (CS) for an active connection established with the mobile radio 16. Data packets to be transmitted to the mobile station are sent from the anchor node (AN) 18 to the radio base stations A and B. In this example, the anchor node 18 marks each sent packet with a common sequence number. The mobile station 16 periodically checks one or more predefined criteria by which to evaluate the radio base stations in the candidate set (e.g., radio conditions, radio channel quality, instantaneous cell or system load, etc.) and finds the most suitable or best cell within its candidate set for reception of the next packet(s).

For example, in FIG. 7, at the time a packet #1 is to be transmitted, the mobile station selects, based on for example radio link quality, a cell governed by base station B and sends an indication to base station B of the selection. In this way, the mobile station only has radio base station B schedule transmission of packet #1 to the mobile station. But at the next transmission interval shown in FIG. 8, the radio link quality situation has changed with a link to base station A being more favorable that the link to base station B. So the mobile station requests that the radio base station A schedule transmission of packet #2 to the mobile radio. Comparing FIGS. 7 and 8, it can be seen that packet #1 was deleted from base station A without transmission from base station A, because the mobile station indicated that packet #2 was the next packet to be transmitted from base station A.

In this distributed scheduling environment, different techniques may be used to inform the radio base stations in the candidate set as to which base station will be transmitting the next packet so as to avoid data loss and packet duplications. One technique is for the mobile radio to explicitly indicate in each request to a base station to transmit a packet sequence number or other identifier of a latest, successfully-received packet to a “new” radio base station so that this “new” radio base station can schedule transmission of the correct next packet. Another approach is for the mobile radio to request a particular packet, or several successive packets, using the sequence number(s) obtained from a radio base station in the candidate set. This approach assumes that the mobile radio has received all of its packets up to that sequence number. A third technique keeps the packet transmission with a current radio base station until the mobile radio informs the radio base station to stop. In FIG. 8, for example, the mobile could send a “Stop” signal to an “old” radio base station B whose cell was previously selected after receiving packet #1 and a “Commence” signal to the “new” selected radio base station A with an “ACK” of packet #2. Having received that “ACK,” the new radio base station A schedules transmission to the mobile of the first unacknowledged packet in its buffer.

“Continuous” transmission from one radio base station is illustrated in the examples in FIGS. 8-11 from radio base station A illustrated by a dashed line between radio base-station A and the mobile radio. Consequently, the packets in front or top of the buffers in the non-active radio base stations are discarded. In the example figures, the buffers store three packets, although different size buffers may be used. For smaller buffers, a packet flow control (e.g., back-pressure) method may be used, where a transmitting radio base station informs the anchor node of the available buffer space in its buffer.

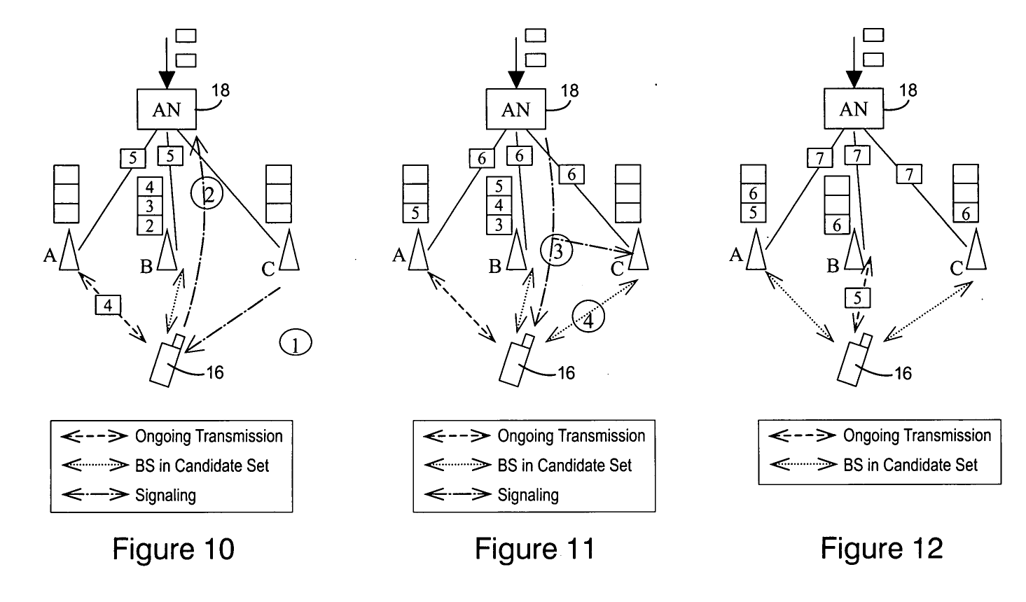

In FIG. 10, the mobile station detects through signal quality measurements that the signal quality associated with the cell governed by radio base station C has improved (indicated at the signal labelled 1). The mobile produces a measurement report transmitted to the anchor node (indicated at the signal labelled 2) or any equivalent node responsible for control signalling. So both base stations B and C are included in the mobile 16's candidate set. Meanwhile, the selected packet transmission scheduling continues with radio base station A transmitting packet #4 to mobile 16.

Based on the measurement report, some sort of signal quality threshold(s), and possibly on other criteria, such as, but not limited to, cell load, transport network capacity, etc., the anchor node or other control node includes the cell governed by radio base station C in the candidate cell set for the mobile radio. This is communicated in a signalling message (3) sent to the mobile radio and to the radio base station C from the access node 18. An advantageous feature to facilitate lossless and seamless transmission in this situation is to include in the message (3) a packet sequence number or other identifier of the first packet that is forwarded to radio base station C. In the illustration shown in FIG. 11, the message (3) identifies packet #6. It may also be desirable for the anchor node to buffer packets for a short time, so that packets already-transmitted to radio base stations A and B can somewhat later be forwarded to radio base station C.

In FIG. 12, even though the radio base station C is now in the candidate set, the mobile radio maintains its transmission selection with radio base station B since it is aware that packet #5 is not available in radio base station C (observe that the buffer in radio base station B is purged due to the request of packet #5). In case of poor link quality (or congestion) to radio base stations A and B, the mobile radio could still select transmission from a cell governed by radio base station C knowing that the cost is a lost packet #5.

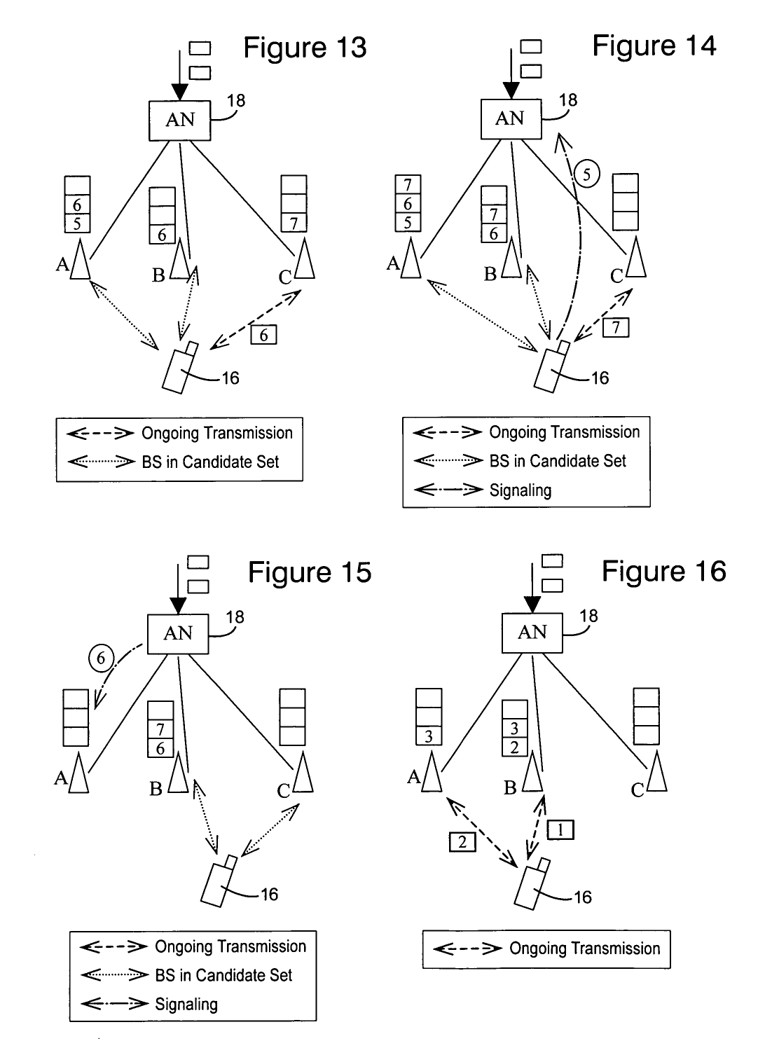

In FIGS. 13 and 14, the mobile radio 16 selects the cell governed by the “new” radio base station C to transmit packet #6 and packet #7, respectively. In FIG. 14, mobile radio measurements of the radio conditions for communicating with base station A indicate a low radio link quality to radio base station A. The mobile radio sends a measurement report with that link quality information to the anchor node with signalling message 5. In FIG. 15, the access node sends a signalling message 6 to base station A to release base station A as a result of the low quality radio link. Accordingly, the cell governed by base station A is removed from the mobile radio's active candidate cell set. Base station A discards any packets stored for this mobile connection and releases the buffer used to hold packets for the connection with the mobile radio.

Another non-limiting example embodiment relates to mobiles capable of receiving two or more data packet streams simultaneously or in parallel. For example, the mobile radio may request transmission of multiple packets from two cells at the same time, as illustrated in the simple example in FIG. 16. Here, the mobile radio requests that packet #1 be transmitted to the mobile from a cell governed by radio base station B at the same time as packet #2 is transmitted by radio base station A to the mobile radio.

Link layer procedures facilitating the transmission of the referenced packets between the radio base stations and the mobile radio may include—but are not limited to—HARQ between the radio base station and the mobile radio, link-adaptation for efficient modulation and coding to the prevailing link quality between the selected radio base-station and the mobile radio, and multi-user scheduling. Because packet transmissions from different cells selected by the mobile do not have to be strictly synchronized and coordinated as is required for soft handover, different coding and/or modulation schemes may be used for the different cell transmissions to the mobile radio. Because that strict coordination is not necessary, multi-user scheduling at each base station is much simpler. Uplink transmissions from the mobile radio may also be carried over a connection to the selected cell or over a connection to a different cell within the active candidate cell set.

The select diversity technology described above has many advantages and applications. It involves both the radio network and the mobile radio in the process of obtaining information relevant to candidate cell connections to the mobile and in the process of selecting the best of those cells for a particular packet transmission over that connection. It also provides fast, efficient, and reliable cell change procedure that enables handover without data packet loss or duplication. This is particularly advantageous in a cellular radio communications system with limited user-plane mobility functionality in anchor nodes. The select diversity technology also ensures that a mobile radio receives data from at least a strong cell in the candidate cell set even under fading channel conditions. In contrast to existing soft-handover procedures, the select diversity technology facilitates the use of link-adaptation (modulation and coding) as well as multi-user scheduling from each base-station.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. A method implemented in a base station for transmitting data on a downlink from a radio access network to a mobile radio, the radio access network including radio base stations, where each radio base station is associated with one or more cells, and where a packet communication with the mobile is associated with a candidate set of cells for the mobile radio that can potentially transmit packets to the mobile radio, the method comprising:
receiving at a first one of the base stations associated with a first one of the cells in the candidate set of cells a packet for possible downlink transmission to the mobile radio;
determining whether the mobile radio has selected the first cell in the candidate set to transmit a packet to the mobile radio; and
if so, the first base station transmitting the packet from the selected first cell to the mobile radio.

2. The method in claim 1, wherein at least a second one of the base stations having a second cell in the candidate set and receiving the packet for possible downlink transmission to the mobile radio is not selected by the mobile radio and therefore does not transmit the packet to the mobile radio.

3. The method in claim 1, wherein at least a second one of the base stations is associated with a second cell in the candidate set,
wherein the second base station having received the packet for possible downlink transmission to the mobile radio and been selected by the mobile radio, transmits the packet to the mobile radio, and
wherein the packet transmissions from the first and second base stations need not be synchronized.

4. The method in claim 1, wherein at least a second one of the base stations is associated with a second cell in the candidate set, the first and second base stations receiving the packets for possible downlink transmission to the mobile radio, and wherein when a first cell in the first base station is selected by the mobile radio, the first base station transmits a packet to the mobile radio using a first modulation and/or coding scheme different from a second modulation and/or coding scheme used by the second base station to transmit a packet to the mobile radio.

5. The method in claim 1, wherein the selection is part of a handover operation or part of a cell selection operation.

6. The method in claim 1, wherein the selecting step is based on one or more factors including one or more radio conditions, one or more radio network conditions, or one or more mobile radio subscription conditions.

7. The method in claim 1, further comprising the first base station receiving an acknowledgement of a packet previously-received by the mobile radio.

8. The method in claim 1, further comprising the first base station receiving a packet identifier of a previously-received data packet or of a packet to be transmitted by the first base station.

9. The method in claim 1, further comprising each radio base station having a cell in the candidate set buffering in a buffer one or more packets to be transmitted downlink to the mobile radio and removing from its buffer one or more packets transmitted by another one of the radio base stations having a cell in the candidate set.

10. A method for use in transmitting data on a downlink from a radio access network to a mobile radio, the radio access network including radio base stations, where each radio base station is associated with one or more cells, the method including defining a candidate set of cells for the mobile radio, the method comprising:
sending packets to be transmitted to the mobile radio from a node to each base station associated with at least one of the cells in the candidate set of cells, where the mobile radio selects which of the base stations associated with at least one of the cells in the candidate set of cells will transmit a specific packet to the mobile radio.

11. The method in claim 10, further comprising:
receiving at the node information associated with the mobile station regarding one or more conditions associated with cells in the candidate set, and
adding a new cell to the candidate set, deleting an existing cell from the candidate set, or both based on the received information.

12. The method in claim 11, further comprising:
after a cell is added or deleted, identifying which base stations are associated with at least one of the cells in the candidate set of cells, and broadcasting packets to be transmitted to the mobile radio only to those identified base stations.

13. The method in claim 10, wherein the node is an anchor node in the radio access network with limited radio link management functionality, the method further comprising broadcasting packets to be transmitted to the mobile radio from a node to each base station associated with at least one of the cells in the candidate set of cells.

14. A method implemented in a mobile radio for facilitating transmission of data downlink from a radio access network to the mobile radio, the radio access network including radio base stations, where each radio base station is associated with one or more cells, and where the mobile radio is associated with a candidate set of cells having base stations that receive packets to be transmitted to the mobile station, the method comprising:
selecting a cell in the candidate set for transmitting a packet to the mobile radio;
signalling to the radio base station associated with the selected cell to transmit the packet to the mobile radio; and
receiving the packet from the selected cell.

15. The method in claim 14, wherein the selecting step includes selecting two or more cells in the candidate set which are associated with different base stations to transmit the packet to the mobile radio.

16. The method in claim 15, wherein the selection is part of a handover operation or part of a cell selection operation.

17. The method in claim 14, wherein the selecting step includes selecting two or more cells in the candidate set which are associated with different base stations to transmit different packets to the mobile radio.

18. The method in claim 14, wherein the selecting step is based on one or more factors including one or more radio conditions, one or more radio network conditions, or one or more mobile radio subscription conditions.

19. The method in claim 14, wherein the signalling step includes sending an acknowledgement of a previously-received data packet.

20. The method in claim 14, wherein the signalling step includes sending a packet identifier of a previously-received data packet or of a packet to be transmitted by the selected base station.

21. The method in claim 14, further comprising:
sending a signal to the one base stations associated with a previously-selected cell to stop transmitting to the mobile radio from the previously-selected cell.

22. Apparatus for use in transmitting data on a downlink from a radio access network to a mobile radio, the radio access network including radio base stations where each radio base station is associated with one or more cells, and where a packet communication with the mobile is associated with a candidate set of cells for the mobile radio that can potentially transmit packets to the mobile radio, the apparatus comprising:
a receiver for receiving at a first one of the base stations associated with a first one of the cells in the candidate set of cells a packet for possible downlink transmission to the mobile radio;
processing circuitry configured to determine whether the mobile radio has selected the first cell in the candidate set to transmit a packet to the mobile radio; and
a transmitter at the first base station for transmitting the packet from the selected first cell to the mobile radio if the processing circuitry determines that the mobile radio has selected the first cell in the candidate set to transmit a packet to the mobile radio.

23. A system including the apparatus in claim 22, wherein at least a second one of the base stations having a second cell in the candidate set and receiving the packet for possible downlink transmission to the mobile radio is configured to not transmit the packet to the mobile radio if the second base station is not selected by the mobile radio to transmit the packet to the mobile radio.

24. A system including the apparatus in claim 22, wherein at least a second one of the base stations having a second cell in the candidate set and receiving the packet for possible downlink transmission to the mobile radio is configured to transmit the packet to the mobile radio if the second base station is selected by the mobile radio to transmit the packet to the mobile radio
wherein the packet transmissions from the first and second base stations need not be synchronized.

25. A system including the apparatus in claim 22, wherein at least a second one of the base stations is associated with a second cell in the candidate set, the first and second base stations configured to receive the packets for possible downlink transmission to the mobile radio, and wherein when the first base station is selected by the mobile radio, the first base station is configured to transmit a packet to the mobile radio using a first modulation and/or coding scheme different from a second modulation and/or coding scheme that the second base station is configured to use to transmit a packet to the mobile radio.

26. The apparatus in claim 22, wherein the selection is part of a handover operation or part of a cell selection operation.

27. The apparatus in claim 22, wherein the selection is based on one or more factors including one or more radio conditions, one or more radio network conditions, or one or more mobile radio subscription conditions.

28. The apparatus in claim 22, wherein the receiver is configured to receive an acknowledgement of a packet previously-received by the mobile radio and to receive a packet identifier of a previously-received data packet or of a packet to be transmitted by the first base station.

29. The apparatus in claim 22, further comprising:
a buffer for buffering one or more packets to be transmitted downlink to the mobile radio and removing from the buffer one or more packets transmitted by another one of the radio base stations having a cell in the candidate set.

30. An anchor node for use in transmitting data on a downlink from a radio access network to a mobile radio, the radio access network including radio base stations where each radio base station is associated with one or more cells, the anchor node including a memory for storing a candidate set of cells for the mobile radio, the anchor node comprising:
communications circuitry for sending packets to be transmitted to the mobile radio to each base station associated with at least one of the cells in the candidate set of cells, where the mobile radio selects which of the base stations associated with at least one of the cells in the candidate set of cells will transmit a specific packet to the mobile radio.

31. The anchor node in claim 30, wherein the communications circuitry is configured to receive information associated with the mobile station regarding one or more conditions associated with cells in the candidate set, the apparatus further comprising:
processing circuitry for adding a new cell to the candidate set, deleting an existing cell from the candidate set, or both based on the received information.

32. The anchor node in claim 31, wherein the processing circuitry is configured to identify which base stations are associated with at least one of the cells in the candidate set of cells and broadcasting packets to be transmitted to the mobile radio only to those identified base stations after a cell is added or deleted.

33. The anchor node in claim 30, wherein the anchor node is located in the radio access network and is configured to provide limited radio link management functionality and to broadcast packets to be transmitted to the mobile radio to each base station associated with at least one of the cells in the candidate set of cells.

34. A mobile radio for facilitating transmission data a downlink from a radio access network to the mobile radio, the radio access network including radio base stations where each radio base station is associated with one or more cells, and where the mobile radio is associated with a candidate set of cells having base stations that receive packets to be transmitted to the mobile station, the mobile radio comprising:
processing circuitry configured to select a cell in the candidate set for transmitting a packet to the mobile radio;
a radio transmitter for signalling from the mobile radio to the radio base station associated with the selected cell an indication to transmit the packet to the mobile radio; and
a radio receiver for receiving the packet from the selected cell at the mobile radio.

35. The mobile radio in claim 34, wherein the processing circuitry is configured to select two or more cells in the candidate set which are associated with different base stations to transmit the packet to the mobile radio.

36. The mobile radio in claim 34, wherein the selection is part of a handover operation or part of a cell selection operation.

37. The mobile radio in claim 34, wherein the processing circuitry is configured to select two or more cells in the candidate set which are associated with different base stations to transmit different packets to the mobile radio.

38. The mobile radio in claim 34, wherein the processing circuitry is configured to make the cell selection based on one or more factors including one or more radio conditions, one or more radio network conditions, or one or more mobile radio subscription conditions.

39. The mobile radio in claim 34, wherein the processing circuitry is configured to send a signal to one of the base stations associated with a previously-selected cell to stop transmitting to the mobile radio from the previously-selected cell.
